(19) United States
(12) Patent Application Publication
(10) Pub. No.: US 2025/0260558 A1
(43) Pub. Date: Aug. 14, 2025

(54) DATA PROTECTION

(71) Applicant: STMicroelectronics International N.V., Geneva (CH)

(72) Inventors: Arnaud POULIQUEN, Etival Les Le Mans (FR); Michel Jaouen, Yvre L'eveque (FR)

(21) Appl. No.: 19/018,573

(22) Filed: Jan. 13, 2025

(30) Foreign Application Priority Data
Feb. 13, 2024 (FR) FR2401383

(51) Int. Cl. H04L 9/08; G06F 21/44; G06F 21/57; G06F 21/60

(52) U.S. Cl. CPC H04L 9/0825; G06F 21/44; G06F 21/57; G06F 21/602; H04L 9/0869

(57) ABSTRACT

The present description concerns a system, device and method including providing a software module by a secure device to an electronic device, the software module comprising the installation of a module of a first software program, a first public key, and a value of authentication of the software module, the verification of the software module based on the authentication value, and, if the verification is successful, the installation of the first software program in a memory of the electronic device in association with the first public key, the first public key being used to cipher data values associated with the first software program.

### CROSS-REFERENCED TO RELATED APPLICATIONS

This application claims the priority benefit of French Patent Application No. 2401383, filed on Feb. 13, 2024, entitled “Protection de données,” which is hereby incorporated herein by reference to the maximum extent allowable by law.

### TECHNICAL FIELD

The present disclosure generally concerns the protection of sensitive data of an electronic device.

### BACKGROUND

When a software module originating from an original device is installed in an electronic device, it may be desirable for the original device to have access to data associated with the software.

It is important for the access to these data to be securely performed. In particular, it is important for the data not to be usable by an external device other than the original device.

### SUMMARY

An embodiment provides a method comprising:
providing a software module by a secure device to an electronic device, the software module comprising a module of installation of a first software program, a first public key, and a software module authentication value;
the verification of the software module based on the authentication value;
if the verification is successful, the installing of the first software program in a memory of the electronic device in association with the first public key, the first public key being used to cipher data values associated with the first software program.

According to an embodiment, the above method further comprises:
providing to the secure device, by the electronic device, the data values associated with the first software program and ciphered using the first public key;
deciphering, by the secure device using a first private key stored in the secure device, of the ciphered data values.

According to an embodiment, the memory of the electronic device comprises a memory configured to store a symmetric key, the method further comprising:
the symmetric ciphering of the data associated with the first software program using the first symmetric key;
the asymmetric ciphering of the first symmetric key using the first public key;
providing, by the electronic device, the ciphered data values associated with the first software program, and the ciphered symmetric key, to the secure device;
the deciphering of the ciphered symmetric key using a first private key stored in the secure device; and
the deciphering of the data values associated with the first software program by the secure device and using the deciphered symmetric key.

According to an embodiment, the symmetric key is a random value generated by a random number generator of the electronic device.

According to an embodiment, providing the ciphered data values to the secure device occurs as a result of the reception of data by the first software program.

According to an embodiment, the data associated with the first software program comprise one or more history data values relative to the operation of the first software program.

According to an embodiment, the installation of the first software program, in a memory of the electronic device in association with the first public key, is performed in a secure memory of the secure device.

According to an embodiment, the software module further comprises a module of installation of one or more of second software programs and one or more of associated second public keys, and wherein, if verification is successful, the one or more of second software programs are installed in the memory of the electronic device in association with the one or more of second public keys, the one or more of second public keys being used to cipher data values associated with the one or more of second software programs.

According to an embodiment, the verification of the software module comprises:
the calculation of a signature value of the software module, using a public signature key;
the comparison of the signature value with the authentication value; and
if the two values match, the validation of the authenticity of the software module.

An embodiment provides a system comprising a secure device and an electronic device, the secure device being configured to:
store a first private key;
provide a software module to the electronic device, the software module comprising a first software installation module, a first public key, associated with the first private key, and a software module authentication value,
the electronic device being configured to:
verify the software module based on the authentication value; and
if the verification is successful, install the first software program in a memory of the electronic device in association with the first public key, the first public key being used to cipher data values associated with the first software program.

According to an embodiment, the electronic device is further configured to:
cipher data associated with the first software program, using the first public key; and
provide the ciphered data to the secure device, the secure device being further configured to decipher the ciphered data using the first private key.

According to an embodiment, the electronic device is configured to provide the ciphered data to the secure device as a result of the initiating of a debugging procedure.

According to an embodiment, the data associated with the first software program are history data relative to the operation of the first software program.

An embodiment provides an electronic device comprising:
a memory having a first software program installed therein, the memory further storing a first public key associated with the first software program, the private key associated with the public key being only stored in a secure device, external to the electronic device; and
a cryptographic circuit configured to cipher data associated with the first software program via the first public key,
the device being further configured to provide the ciphered data to the secure device as a result of a debugging procedure.

According to an embodiment, the above electronic device further comprises a symmetric key, stored in the memory and wherein the cryptographic circuit is configured to:
perform a symmetric ciphering of the data associated with the first software program using the symmetric key; and
perform an asymmetric ciphering of the symmetric key, using the first public key,
the electronic device being further configured to provide, with the ciphered symmetric key, the data associated with the first software program, ciphered, to the secure device.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a block diagram showing a system according to an embodiment of the present disclosure;

FIG. 2 illustrates steps of supply and installation of a software module according to an embodiment of the present disclosure;

FIG. 3 illustrates steps of ciphering and supply of sensitive data according to an embodiment of the present disclosure;

FIG. 4 illustrates steps of ciphering and supply of sensitive data according to another embodiment of the present disclosure; and

FIG. 5 is a flowchart illustrating steps of a data protection method according to an embodiment of the present disclosure.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, cryptographic methods, for example implementing asymmetric and/or symmetric cipher and decipher operations, are known by those skilled in the art and are not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

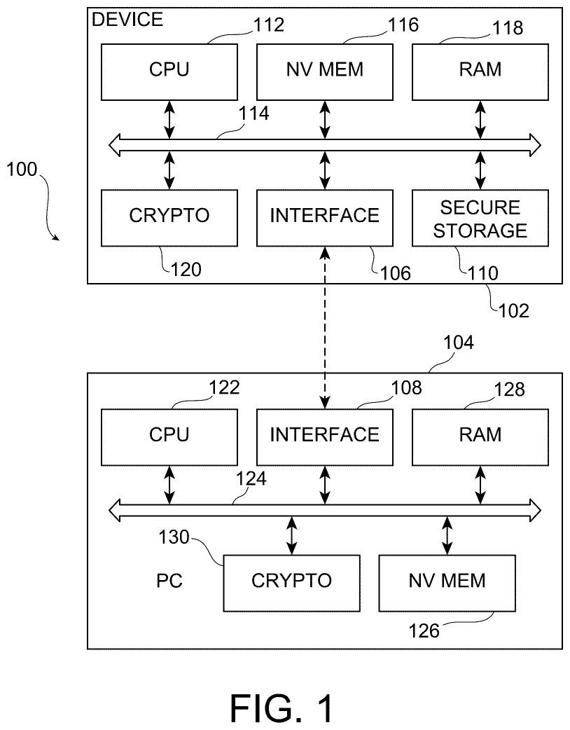

FIG. 1 is a block diagram showing a system 100 according to an embodiment of the present disclosure. In particular, system 100 comprises an electronic device 102 and a secure device 104.

As an example, device 102 is a non-secure electronic device and, for example, may be the target of attacks aiming at obtaining sensitive data stored by device 102. As an example, electronic device 102 is a smart phone, a connected object, a microcircuit card, etc.

As an example, device 104 is a device operating in a secure environment, or comprising a secure circuit. As an example, device 104 is a computer. In this example, secure device 104 is configured to extract data from device 102 and to use them.

In another example, another non-secure device (not illustrated in FIG. 1) is for example positioned between devices 102 and 104. The other non-secure device is configured to extract data from device 102 and to provide the data to secure device 104, which is then configured to use the data.

Electronic devices 102 and 104 comprise, for example, respectively an interface 106 and an interface 108. Interfaces 106 and 108 are, for example, serial wired communication ports, such as USB (Universal Serial Bus) or USB-C ports, or other types of wired communication ports, such as universal asynchronous receiver transmitter (UART) ports, etc. In another example, interfaces 106 and 108 allow the implementation of a wireless communication, for example, a WiFi (Wireless-Fidelity), Bluetooth, NFC (Near Field Communication) communication, etc.

Electronic device 102 comprises, for example, a secure non-volatile memory 110 (SECURE STORAGE) configured to store one or more of software programs. As an example, the one or more of software programs are software programs originating from secure device 104. As an example, the one or more of software programs have, for example, been supplied, via interfaces 106 and 108, prior to the putting into service of device 102.

Device 102 for example further comprises a processor 112 (CPU) coupled to secure memory 110 via a bus 114. As an example, processor 112 is configured to execute instructions allowing the execution of the software program(s). Device 102 further comprises, for example, a non-volatile memory 116 (NV MEM) and a volatile memory 118 (RAM) coupled to bus 114.

Electronic device 102 further comprises a cryptographic circuit 120 (CRYPTO) configured to perform cryptographic operations. As an example, cryptographic circuit 120 is configured to perform symmetric and/or asymmetric cipher and/or decipher operations.

According to an embodiment, secure memory 110 is included in cryptographic circuit 120. As an example, processor 112 and cryptographic circuit 120 are included in a same secure sub-circuit.

Secure device 104 comprises, for example, a processor 122 (CPU) coupled to interface 108 via a bus 124. Secure device 104 further comprises a non-volatile memory 126 (NV MEM) and a volatile memory 128 (RAM) coupled to bus 124. Secure device 104 further comprises a cryptographic circuit 130 (CRYPTO) configured to perform cryptographic operations. As an example, cryptographic circuit 130 is configured to perform symmetric and/or asymmetric cipher and/or decipher operations.

During the operation of device 102 and, in particular, during the execution of the software program(s) originating from device 104, sensitive data are manipulated and/or generated. As an example, the sensitive data comprise trace data of the operation of processor 112 during the execution of the software program(s). The operation trace comprises both a dynamic trace, such as a debug trace, and/or an image of the state of processor 112 (core dump) at the time of an event. It is desirable for device 104 to have access to the sensitive data of the software program(s) as a result, for example, of an interruption in the correct operation of device 102, such as an interruption due to a software bug, and/or to a crash and/or to an attack undergone by device 102. In particular, it is desirable for no external device, other than device 104, to have access to the sensitive data.

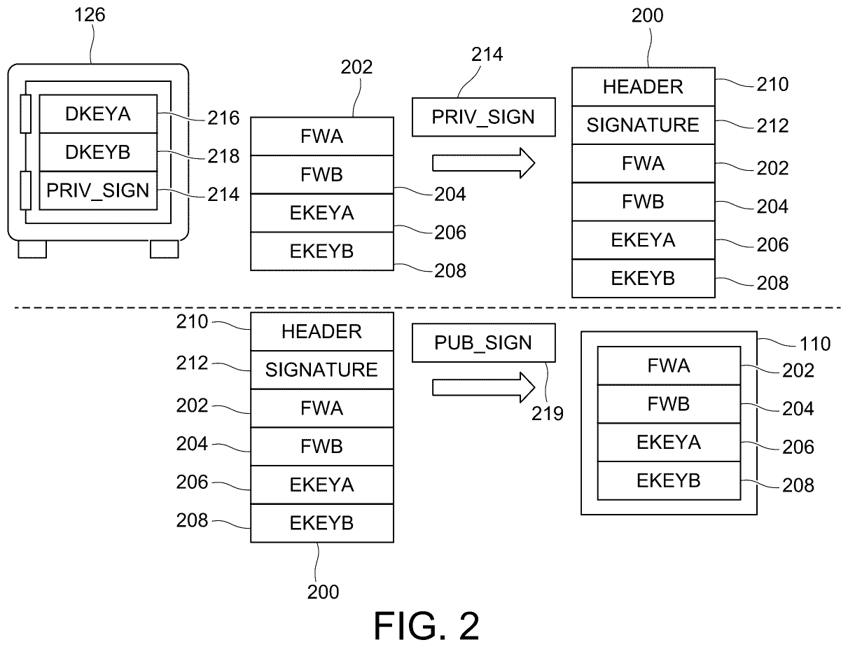

FIG. 2 illustrates steps of supply and installation of software programs, according to an embodiment of the present disclosure. In particular, FIG. 2 illustrates the supply of a software module 200, from secure device 104 and to electronic device 102 and, for example, via interfaces 106 and 108.

Software module 200 comprises, for example, a first software program, or firmware, 202 (FWA). As an example, module 200 further comprises a second software program, or firmware, 204 (FWB). According to an embodiment, module 200 further comprises a first cipher key 206 (EKEYA) associated with the first firmware 202. Module 200 for example further comprises a second cipher key 208 (EKEYB) associated with the second firmware 204. As an example, key 206 and/or 208 are public cipher keys.

Software module 200 for example further comprises a header 210 (HEADER) and an authentication value 212 (SIGNATURE). As an example, header 210 comprises information such as, for example, the version of the software program. Header 210 for example further comprises indications enabling device 102 to extract and to process the data contained in module 200.

As an example, authentication value 212 is a signature. Authentication value 212 is, for example, calculated by device 104 and via a key 214 (PRIV_SIGN), for example a private key, included in device 104. As an example, key 214 is included in the non-volatile memory 126 of device 104. In another example, private key 214 is included in a secure memory of secure device 104. Authentication value 212 is calculated based on software program 202 and 204 and on cipher keys 206 and 208.

According to an embodiment, device 104 further comprises, for example stored in memory 126, a decipher key 216 (DKEYA) associated with cipher key 206 and with the first software program 202. As an example, keys 206 and 216 form a public/private key pair.

Device 104 for example further comprises a decipher key 218 (DKEYB), stored in memory 126, associated with cipher key 208 and with the second software program 204. As an example, keys 208 and 218 form a public/private key pair.

According to an embodiment, on reception of module 200, device 102 verifies the authenticity and/or the integrity of module 200. For example, the module is verified using a key 219 (PUB_SIGN). As an example, key 219 is a public key forming a public/private key pair with key 214. The authentication and/or the verification of the integrity of module 200 is further performed based on authentication value 212. Key 219 is, for example, provisioned in device 102 on manufacturing thereof.

According to an embodiment, in the case where the authentication and/or the integrity of module 200 is successfully verified, software program 202, and for example software program 204, are installed in the secure memory 110 of device 102. Cipher key 206 is further stored, in association with software program 202, in memory 110.

As an example, module 200 comprises, in certain cases, a number of software programs greater than two. For example, the module comprises a third software program and a cipher key associated with the third software program.

As an example, module 200 comprises a plurality of software programs associated with a single cipher key, for example key 206. In this example, key 206 is a cipher key associated with software programs 202 and 204.

Once installed in memory 110, software program 204 is for example executed by processor 112, and data are for example generated. As an example, these data comprise history data relative to the software operation. Key 106 is for example used to extract ciphered data during the operation of processor 112 or in case of a malfunction. As an example, the supply of these data to secure device 104 enables the latter to analyze a potential cause of the malfunction. However, it is important for the supply of these data to be performed in secure manner, so that no one, other than secure device 104, has access to the values of the supplied data.

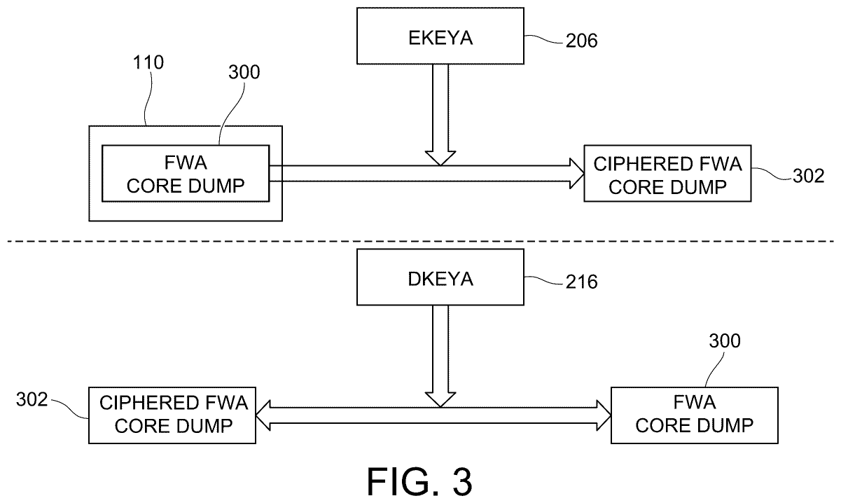

FIG. 3 illustrates steps of ciphering and of supply of sensitive data, according to an embodiment of the present description.

As a result of a malfunction, secure device 102, and in particular cryptographic circuit 120, is configured to encrypt sensitive data 300 (FWA CORE DUMP), such as for example history data, stored in secure memory 110 in association with the first software program 202. Data 300 are for example ciphered using cipher key 206. Cryptographic circuit 120 then generates ciphered data 302 (CIPHERED FWA CORE DUMP) and these data 302 are supplied, for example via interfaces 106 and 108, to secure device 104.

On reception of ciphered data 302, cryptographic circuit 130 is configured to decipher the ciphered data 302, via decipher key 216, in order to recover sensitive data 300. Decipher key 216 being only known by secure device 104, which is a secure environment, a device external to device 102 and other than device 104 is unable to decipher the ciphered data 302. Thus, only secure device 100 has access to sensitive data 300.

In the example where memory 110 comprises the second software program 204 and the second cipher key 208, the cryptographic circuit is further configured to cipher the sensitive data associated with software program 204 using cipher key 208. In this example, the cryptographic circuit 130 of secure device 104 is configured to decipher the ciphered sensitive data associated with the second software program 204 using decipher key 218.

In another example, the sensitive data associated with software program 204 are ciphered using cipher key 206. The deciphering of these data, by cryptographic circuit 130, is performed using decipher key 216.

The cryptographic operations for the ciphering and the deciphering of data 300 are, for example, asymmetric cipher operations.

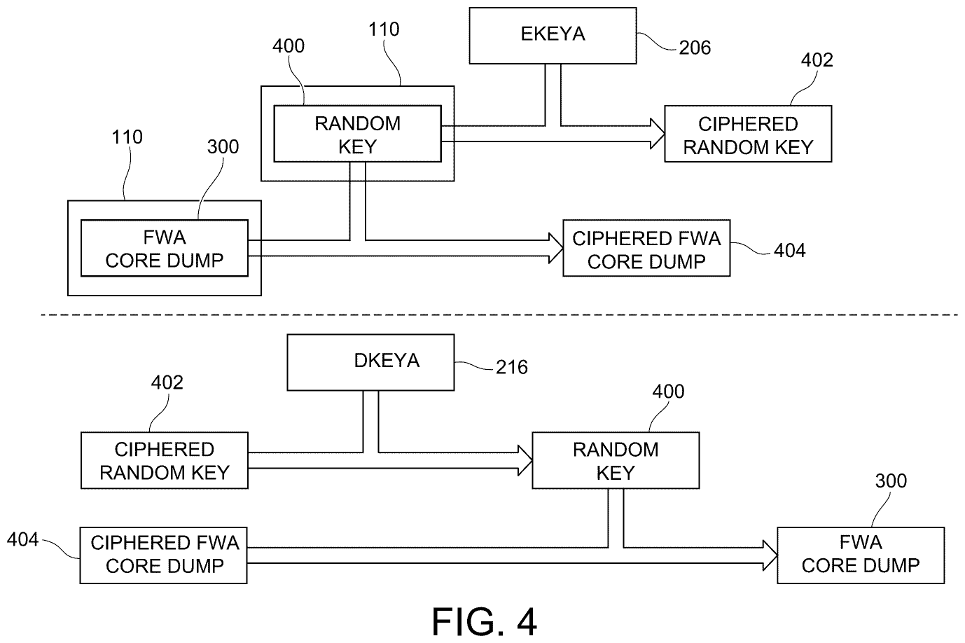

FIG. 4 illustrates steps of ciphering and supply of sensitive data 300, according to another embodiment of the present disclosure.

According to an embodiment, secure memory 110 further comprises a symmetric cipher key 400 (RANDOM KEY). As an example, symmetric cipher key 400 has been randomly generated, for example by a number generator of device 102.

According to an embodiment, cryptographic circuit 120 is configured to generate a ciphered symmetric cipher key 402 by ciphering cipher key 400 using cipher key 206. As an example, the cryptographic operations enabling to cipher symmetric cipher key 400 are asymmetric cipher operations. Cryptographic circuit 120 is further configured to generate ciphered sensitive data 404 (CIPHERED FWA CORE DUMP) by ciphering, for example based on symmetric cipher operations, data 300 using symmetric key 400.

The ciphered symmetric key 402 and the ciphered sensitive data 404 are then supplied, for example via interfaces 106 and 108, to secure device 104.

Cryptographic circuit 130 is configured to decipher, for example by executing asymmetric cipher operations, the ciphered cipher key 402 using decipher key 216 and thus recover the value of symmetric cipher key 400. Cryptographic circuit 130 is further configured to decipher, for example by executing symmetric cipher operations, the ciphered sensitive data 404 and thus recover the values of sensitive data 300.

In the example where memory 110 comprises the second software program 204 and the second cipher key 208, cryptographic circuit 120 is further configured to generate a second ciphered symmetric cipher key, for example by ciphering cipher key 400 using cipher key 208. In this example, the cryptographic circuit 130 of secure device 104 is configured to decipher the ciphered sensitive data, associated with the second software program 204, using decipher key 218 and of the second ciphered symmetric cipher key.

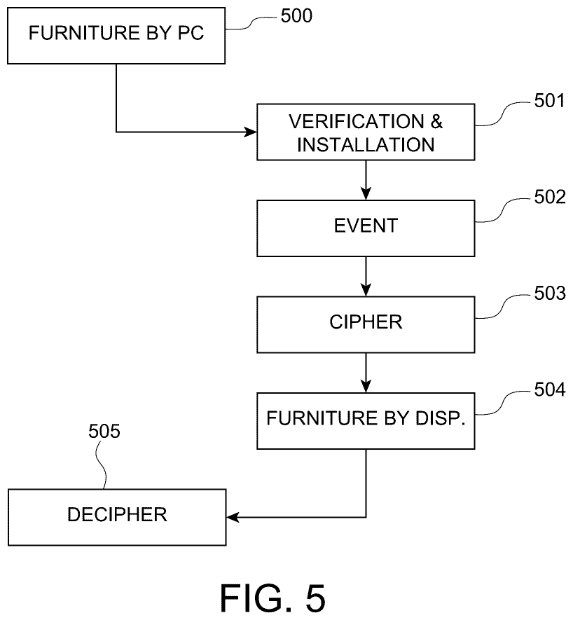

FIG. 5 is a flowchart illustrating steps of a data protection method according to an embodiment of the present disclosure.

At a step 500 (FURNITURE BY PC), secure device 104 supplies a software module to electronic device 102. The software module is, for example, similar to module 200 and comprises one or more of software programs intended to be installed in device 102. The module further comprises one or more of cipher keys, such as for example public keys, in association with the software program(s), such as described in relation with FIG. 2.

At a step 501 (VERIFICATION & INSTALLATION), device 102 verifies the integrity and/or the authenticity of the received module. As an example, the verification is performed based on a verification of an authentication value, such as for example a signature value. As an example, the verification of the module comprises the implementation of asymmetric cipher operations using a public key, known by electronic device 102. In this example, the private key forming a pair with the public key is known by secure device 104.

As an example, authentication value 212 is a signature value, for example calculated by secure device 104. Authentication value 212 for example corresponds to a value resulting from the ciphering, using key 214, of software program 202 and/or 204 and of keys 206 and/or 208. Device 102 is then configured to recalculate authentication value 212 based on module 200 and on key 219, and to compare the obtained value with authentication value 212. The authentication and/or the integrity of the software is, for example, validated when the two values match.

In the case where the verification fails (not shown in the flowchart), the method ends, with no installation of the software program(s). As an example, in this case, the module is removed from electronic device 102.

In the case where the verification is successful, the software program(s) are installed, in association with the cipher key(s), in secure memory 110.

In a possible step 502 (EVENT), data are transmitted to software module 104 or to a third party module knowing key 206. In an example, these data are transmitted when electronic circuit 102 undergoes a malfunction, such as for example a crash, a bug, or an attack.

As a result of step 502, cryptographic circuit 120 ciphers, during the carrying out of step 503 (CIPHER), the sensitive data associated with the software programs. As an example, the ciphered sensitive data are history data tracing back the operation of the software program(s). The data ciphering is carried out, for example, as described in relation with FIGS. 3 and/or 4.

At a step 504 (FURNITURE BY DISP.), electronic device 102 supplies, for example, via interface 106, the ciphered sensitive data, at step 503, to secure device 104. As an example, when the ciphering of the sensitive data is performed according to the embodiment described in relation with FIG. 4, the ciphered data comprise the ciphered symmetric cipher key.

At a step 505 (DECIPHER), secure circuit 104, and in particular cryptographic circuit 130, deciphers the received ciphered data. The deciphering of the data is for example carried out as described in relation with FIGS. 3 and/or 4. Once the sensitive data have been recovered, secure circuit 104 manipulates them and, for example, analyzes the cause of the malfunction.

An advantage of the described embodiments is that they allow the provision of sensitive data associated with software programs to a device, in secure fashion. Indeed, the decipher keys required for the deciphering of the provisioned data are known to the device only.

Various embodiments and variants have been described. Those skilled in the art will understand that certain features of these various embodiments and variants may be combined, and other variants will occur to those skilled in the art. In particular, the cipher methods used for the ciphering and/or the deciphering may vary.

Finally, the practical implementation of the described embodiments and variants is within the abilities of those skilled in the art based on the functional indications given hereabove.

What is claimed is:

1. A method comprising:
providing, by a secure device to an electronic device, a software module comprising a first installation module of a first software program, a first public key, and an authentication value of the software module;
attempt, by the electronic device, a verification of the software module based on the authentication value; and
in response to the verification being successful, installing, by the electronic device, the first software program in a memory of the electronic device in association with the first public key; and
ciphering, by the electronic device, data values associated with the first software program using the first public key.

2. The method according to claim 1, further comprising:
providing, by the electronic device to the secure device, the ciphered data values associated with the first software program; and
deciphering, by the secure device using a first private key stored in the secure device, the ciphered data values.

3. The method according to claim 1, further comprising:
storing, by the memory of the electronic device, a symmetric key;
symmetrically ciphering the data values associated with the first software program using the symmetric key;
asymmetrically ciphering the symmetric key using the first public key;
providing, by the electronic device to the secure device, the symmetrically ciphered data values associated with the first software program, and the asymmetrically ciphered symmetric key;
deciphering, by the secure device, the asymmetrically ciphered symmetric key using a first private key stored in the secure device; and
deciphering, by the secure device, the symmetrically ciphered data values associated with the first software program using the deciphered symmetric key.

4. The method according to claim 3, wherein the symmetric key is a random value generated by a random number generator of the electronic device.

5. The method according to claim 2, wherein providing the ciphered data values to the secure device occurs in response to the first software program receiving data.

6. The method according to claim 1, wherein the data values associated with the first software program comprise one or more history data values relative to an operation of the first software program.

7. The method according to claim 1, wherein installing the first software program in the memory of the electronic device, in association with the first public key, is carried out in a secure memory of the electronic device.

8. The method according to claim 1, wherein the software module further comprises a second installation module of one or more second software programs and one or more associated second public keys, and the method comprises:
in response to the verification being successful, installing, by the electronic device, the one or more second software programs in the memory of the electronic device in association with the one or more associated second public keys; and
ciphering, by the electronic device, second data values associated with the one or more second software programs using the one or more associated second public keys.

9. The method according to claim 1, wherein the verification of the software module comprises:
calculating a signature value of the software module, using a public signature key;
comparing the signature value with the authentication value; and
in response to the signature value matching the authentication value, validating an authenticity of the software module.

10. A system comprising:
a secure device configured to:
store a first private key; and
provide, to an electronic device, a software module comprising a first installation module of a first software program, a first public key associated with the first private key, and an authentication value of the software module; and
the electronic device, configured to:
attempt a verification of the software module based on the authentication value;
in response to the verification being successful, install the first software program in a memory of the electronic device in association with the first public key; and
cipher data values associated with the first software program using the first public key.

11. The system according to claim 10, wherein:
the electronic device is further configured to provide the ciphered data values to the secure device; and
the secure device is further configured to decipher the ciphered data values using the first private key.

12. The system according to claim 11, wherein the electronic device is configured to provide the ciphered data values to the secure device in response to an initiation of a debugging procedure.

13. The system according to claim 11, wherein the data values associated with the first software program are history data relative to an operation of the first software program.

14. The system according to claim 10, wherein:
the electronic device is further configured to:
store, in the memory of the electronic device, a symmetric key;
symmetrically cipher the data values associated with the first software program using the symmetric key;
asymmetrically cipher the symmetric key using the first public key; and
provide, to the secure device, the symmetrically ciphered data values associated with the first software program, and the asymmetrically ciphered symmetric key; and
the secure device is further configured to:
decipher the asymmetrically ciphered symmetric key using the first private key stored in the secure device; and
decipher the symmetrically ciphered data values associated with the first software program using the deciphered symmetric key.

15. The system according to claim 14, wherein the symmetric key is a random value generated by a random number generator of the electronic device.

16. An electronic device comprising:
a memory storing a first software program, and a public key associated with the first software program, the public key associated with a private key stored only in a secure device external to the electronic device;
a cryptographic circuit configured to cipher data associated with the first software program using the public key; and
a communication interface configured to provide the ciphered data to the secure device in response to a debugging procedure.

17. The electronic device according to claim 16, wherein:
the memory further stores a symmetric key;
the cryptographic circuit is further configured to:
perform a symmetric ciphering of the data associated with the first software program using the symmetric key; and
perform an asymmetric ciphering of the symmetric key using the public key; and
the communication interface is further configured to provide, to the secure device, the asymmetrically ciphered symmetric key, and the symmetrically ciphered data associated with the first software program.

18. The electronic device according to claim 17, wherein the symmetric key is a random value generated by a random number generator of the electronic device.

19. The electronic device according to claim 16, wherein the electronic device further comprises a processor configured to install the first software program in a secure memory of the electronic device in association with the public key.

20. The electronic device according to claim 16, wherein:
the memory stores a second software program and an associated second public key; and
the cryptographic circuit is further configured to cipher second data associated with the second software program using the associated second public key.
